(19) United States
(12) Patent Application Publication
(10) Pub. No.: US 2010/0325145 A1
(43) Pub. Date: Dec. 23, 2010

(54) SEARCH WORD CANDIDATE OUTPUTTING APPARATUS, SEARCH APPARATUS, SEARCH WORD CANDIDATE OUTPUTTING METHOD, COMPUTER-READABLE RECORDING MEDIUM IN WHICH SEARCH WORD CANDIDATE OUTPUTTING PROGRAM IS RECORDED, AND COMPUTER-READABLE RECORDING MEDIUM IN WHICH DATA STRUCTURE IS RECORDED

(75) Inventor: Takashi HASHIMOTO, Yokohama-city (JP)

Correspondence Address: YOUNG & THOMPSON, 209 Madison Street, Suite 500, Alexandria, VA, 22314, US

(73) Assignees: PIONEER CORPORATION, Tokyo (JP); INCREMENT P CORPORATION, Tokyo (JP); MOBILEMEDIA BRAIN ASSOCIATION, INC., Tokyo (JP)

(21) Appl. No.: 12/777,663

(22) Filed: May 11, 2010

(30) Foreign Application Priority Data
Jun. 17, 2009 (JP) 2009-144544

(51) Int. Cl. G06F 17/30

(52) U.S. Cl. 707/769; 707/E17.014

(57) ABSTRACT

A search word candidate outputting apparatus includes: a keyword database storing a pair of word/phrase-attribute information composed of a word/phrase inputted as a keyword, and attribute information indicating an attribute of a word/phrase as a keyword, a next word predictive candidate database configured to store a pair of attribute information-sentence composed of the attribute information, and a sentence expected to be inputted together with the word/phrase for which the attribute is indicated by the attribute information, a next word predictive candidate extraction device that, based on a pair of word/phrase-attribute information, extracts attribute information corresponding to a word/phrase from the keyword type database, and based on a pair of attribute information-sentence, extracts a sentence which constitutes a pair of attribute information-sentence together with the attribute information, from the next word predictive candidate database, and a display configured to display the inputted word/phrase and the extracted sentence, as a candidate.

### BACKGROUND OF THE INVENTION

1. Field of the Invention

The present invention relates to a technical field of a search word candidate outputting apparatus, a search apparatus, a search word candidate outputting method, a computer-readable recording medium in which a search word candidate outputting program is recorded, and a computer-readable recording medium in which a data structure is recorded.

In particular, the present invention relates to a technical field of a search word candidate outputting apparatus which outputs a candidate for determining a search word used in a search for a location or the like, a search word candidate outputting method, a search apparatus which comprises the search word candidate outputting apparatus, a computer-readable recording medium in which a search word candidate outputting program is recorded, and a computer-readable recording medium in which a data structure is recorded.

2. Discussion of Related Art

In recent years, for example, at the time of search for a destination in a a navigation apparatus or the like, a method of conducting a search using a search word inputted in a free fashion, i.e., a so-called free keyword search method is used. In this search method, it is possible to input a keyword, not using a predetermined form or word/phrase, but using a free word/phrase. This search method has an advantage of, for example, making it possible for even an unfamiliar user to conduct a search.

On the other hand, as a free keyword search method, in recent years, based on a word/phrase previously inputted for a search, a search apparatus predicts and displays a word/phrase which may be probably inputted following the previously inputted word/phrase, and displays one or a plurality of predicted words/phrases. With this arrangement, by the fact that a user making a selection of a desired word/phrase from words/phrases being displayed, as compared with the case where all words/phrases to be inputted are inputted by himself, it is possible to input a word/phrase as a search word with a very small effort.

The above process is generally called a predictive conversion process, and as prior art relating thereto, for example, Patent Documents Nos. 1 and 2 mentioned below are provided. In Patent Document No. 1, an arrangement is disclosed in which, in the case where a character is inputted while a television broadcast is being viewed, character information multiplexed with the television broadcast is analyzed, and a keyword indicative of contents of the broadcast is informed as an input candidate for a character input. In Patent Document No. 2, an arrangement is disclosed in which a word/phrase included in inputted text information is identified, a degree of difficulty in the identified word/phrase is determined by a comparison with a data base, and a word/phrase whose degree of difficulty exceeds a predetermined level is informed as a candidate for a keyword.

Here, in the above free-keyword search method, while it is possible to globally input a plurality of kinds of names or the like at the time of inputting a word/phrase as a search word, a method of dividing the respective names with a space or a character code exclusive therefor is used. Concerning a word/phrase used for designating a search method (in particular, a search method, such as “searching for a facility belonging to the genre”, or “searching for a facility whose name includes) , there are a method in which it is automatically determined, and a method in which it is pre-selected from a so-called icon or menu list before a search is conducted. Further, there is also a method in which a so-called drop-down list is displayed, and each word/phrase or an attribute as a search word which it has is designated.

### [Prior Art Document(s)]

### [Patent Document(s)]

Patent Document No. 1: Japanese Patent Laid-open No. 2006-301693
Patent Document No. 2: Japanese Patent Laid-open No. 2008-27186

### SUMMARY OF THE INVENTION

Concerning a conventional free-keyword search method illustrated in the above respective Patent documents in which a predictive conversion is made, however, there is the following problem in a method in which a drop-down list is used: in the case where a plurality of names or the like are inputted, it is necessary to prepare drop-down lists or the like by the number of names or the like to be inputted, and therefore, an arrangement for a search input screen becomes complicated, and a physically big area is occupied on a display.

In the above method in which a search method is automatically determined, there is the following problem: in some cases, a search method which a user does not intend is selected, and as a result, a desired search result cannot be obtained.

Further, in the above method in which an icon or a menu list is used, there is the following problem: in some cases, it is difficult to intuitively understand how a search method changes based on the use of an icon or a menu list, and an instruction manual or the like has to be read in order to understand it. Furthermore, an operation which is composed of a plurality of steps is necessary in order to display such a menu list itself, and as a result, there is the following problem: in some cases, a necessary search result cannot be obtained rapidly at the time of moving or the like.

The present invention has been accomplished in view of the above problem, and it is an object of the invention to provide a search word candidate outputting apparatus capable of recognizing and deciding contents of a search word in a simple arrangement and in a easy-to-understand condition with precision kept as a search word, a search word candidate outputting method, a search apparatus which comprises the search word candidate outputting apparatus, a computer-readable recording medium in which a search word candidate outputting program is recorded, and a computer-readable recording medium in which a data structure is recorded.

In order to solve the above problem, the invention according to claim 1 relates to a search word candidate outputting apparatus, comprising:

a first storage device configured to store a pair of a word/phrase which is expected to be inputted as a search word used for a search, and attribute information indicative of an attribute as a search word of the word/phrase, as a pair of word/phrase-attribute information,

a second storage device configured to store a pair of the attribute information, and a sentence which is expected to be inputted together with the word/phrase for which the attribute is indicated by the attribute information, as a pair of attribute information-sentence,

an attribute information extraction device configured to, based on the stored pair of word/phrase-attribute information, extract the attribute information indicative of the attribute as the search word of the inputted word/phrase, from the first storage device,

a sentence extraction device configured to, based on the stored pair of attribute information-sentence, extract the sentence which constitutes the pair of attribute information-sentence together with the extracted attribute information, from the second storage device, and

an outputting device configured to output the inputted word/phrase and the sentence extracted from the sentence extraction device, as a candidate of the search word.

In order to solve the above problem, the invention according to claim 5 relates to a search apparatus, comprising:

a search word candidate outputting apparatus according to claim 1,

an inputting device configured to be used to input instructions of deciding the search word based on the outputted candidate, and

a search device configured to conduct a search using the decided search word.

In order to solve the above problem, the invention according to claim 6 relates to a computer-readable recording medium in which a data structure is recorded,

wherein the data structure is a data structure in the first storage device provided in a search word candidate outputting apparatus according to claim 1,

the data structure includes the pair of word/phrase-attribute information which includes the word/phrase and the attribute information corresponding to the word/phrase in such a way that the pairs of word/phrase-attribute information can be identified relative to each other.

In order to solve the above problem, the invention according to claim 7 relates to a computer-readable recording medium in which a data structure is recorded,

wherein the data structure is a data structure in the second storage device provided in a search word candidate outputting apparatus according to claim 1,

the data structure includes the pair of attribute information-sentence which includes the attribute information and the sentence corresponding to the attribute information in such away that the pairs of attribute information-sentence can be identified relative to each other.

In order to solve the above problem, the invention according to claim 8 relates to a search word candidate outputting method performed in a search word candidate outputting apparatus which comprises:

a first storage device configured to store a pair of a word/phrase which is expected to be inputted as a search word used for a search, and attribute information indicative of an attribute as a search word of the word/phrase, as a pair of word/phrase-attribute information, and

a second storage device configured to store a pair of the attribute information, and a sentence which is expected to be inputted together with the word/phrase for which the attribute is indicated by the attribute information, as a pair of attribute information-sentence,

the method comprising:

an attribute information extraction step of, based on the stored pair of word/phrase-attribute information, extracting the attribute information indicative of the attribute as the search word of the inputted word/phrase, from the first storage device,

a sentence extraction step of, based on the stored pair of attribute information-sentence, extracting the sentence which constitutes the pair of attribute information-sentence together with the extracted attribute information, from the second storage device, and

an outputting step of outputting the inputted word/phrase and the sentence extracted from the sentence extraction device, as a candidate of the search word.

In order to solve the above problem, the invention according to claim 9 relates to a computer-readable recording medium in which a search word candidate outputting program is recorded,

the program making a computer function as a search word candidate outputting apparatus according to claim 1.

### BRIEF DESCRIPTION OF THE DRAWINGS

FIG. 1 is a block diagram showing a schematic arrangement of a search apparatus according to the embodiment.

FIGS. 2A and 2B are views of illustrating contents of each data base according to the embodiment, and FIG. 2A is a view illustrating contents of a keyword type data base according to the embodiment, and FIG. 2B is a view illustrating contents of a next word predictive candidate data base according to the embodiment.

FIG. 3 is a flowchart showing a search operation according to the embodiment.

FIG. 4 is a view illustrating a search screen displayed in a search operation according to the embodiment.

FIGS. 5A to 5E are views illustrating a change of a search screen displayed in a search operation according to the embodiment, and FIG. 5A is a view showing a first example, FIG. 5B is a view showing a second example, FIG. 5C is a view showing a third example, FIG. 5D is a view showing a fourth example, and FIG. 5E is a view showing a fifth example.

FIG. 6 is a view illustrating a search result screen of a search operation according to the embodiment.

FIGS. 7A and 7B are views illustrating a search screen displayed in another search operation according to the embodiment.

### DETAILED DESCRIPTION OF THE PREFERRED EMBODIMENTS

Referring now to the drawings, an embodiment of the present invention will be described. An embodiment which will be described below is an embodiment in the case where the present invention has been applied to a search apparatus which is included in a navigation apparatus which is installed in, for example, a vehicle and which guides the movement of the vehicle, said search apparatus being used, for example, at the time of conducting a search for a destination relating to the guidance or the like.

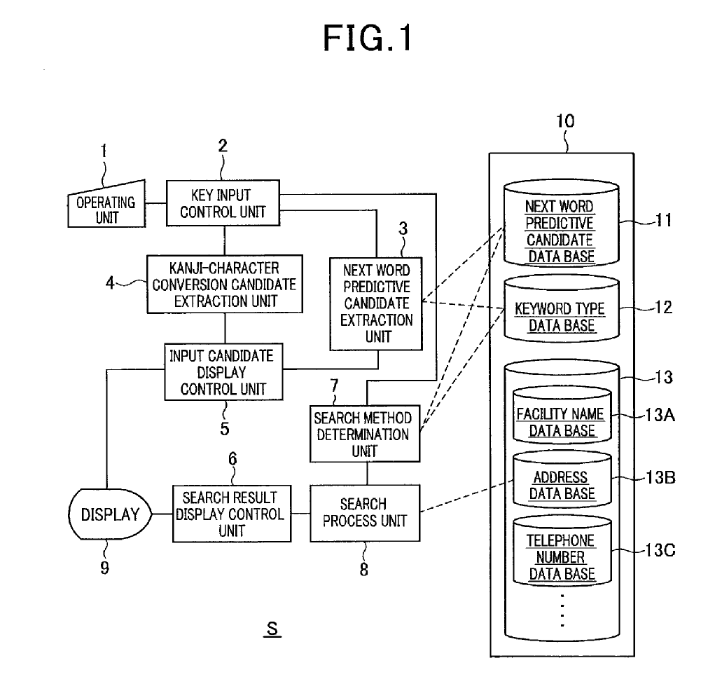

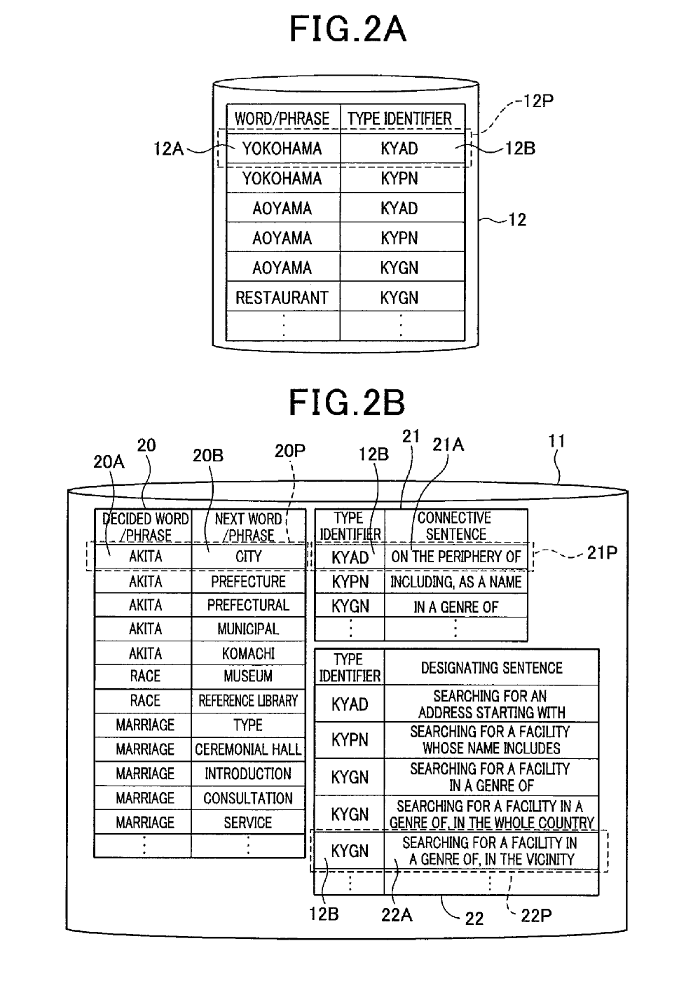

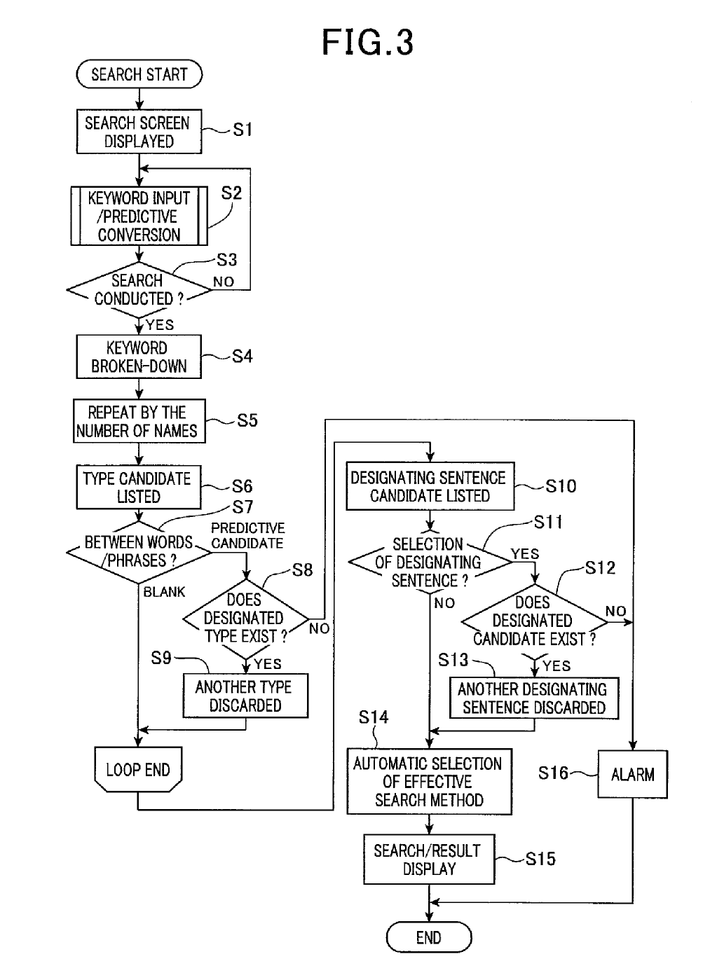

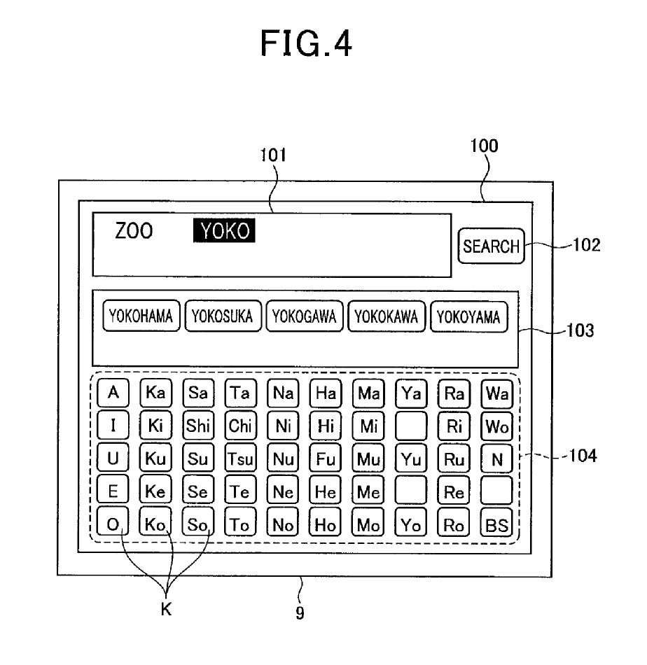

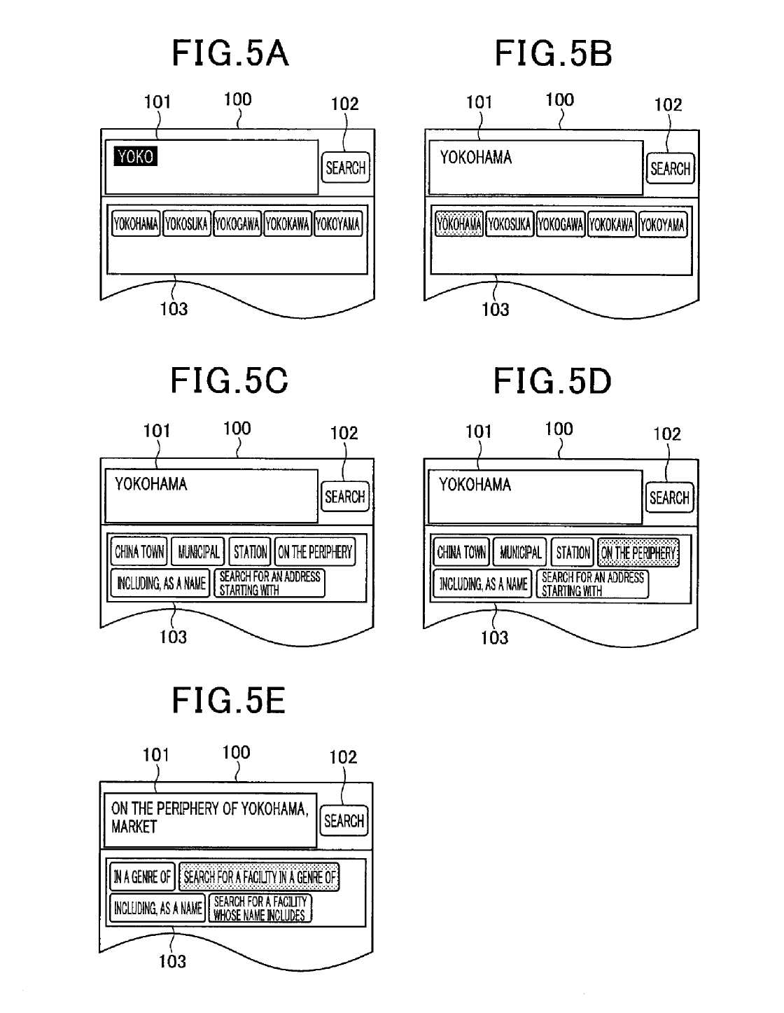

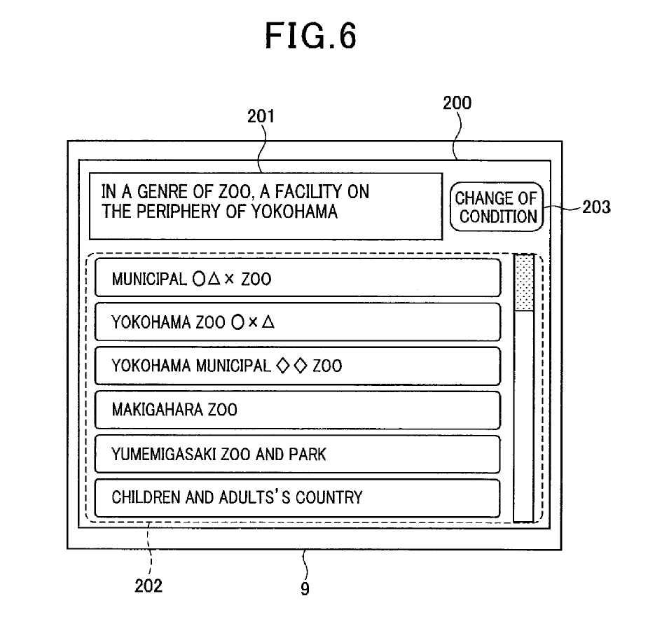

FIG. 1 is a block diagram showing a schematic arrangement of a search apparatus according to the embodiment, FIGS. 2A and 2B are views of illustrating contents of each data base according to the embodiment, and FIG. 3 is a flow chart showing a search operation according to the embodiment. FIGS. 4 and 5 are views illustrating a search screen displayed in the search operation, and FIG. 6 is a view illustrating a search result screen displaying the result of the search operation.

### (I) Arrangement of Search Apparatus

First, an arrangement of a search apparatus according to the embodiment will be described, using FIG. 1 and FIG. 2.

AS shown in FIG. 1, a search apparatus S according to the embodiment comprises: an operation unit 1 as an example of an input device, composed of a keyboard and a mouse or a touch pad or the like, a key input control unit 2, a next word predictive candidate extraction unit 3, as a name structure word/phrase extraction device, an example of an attribute information extraction device, and an example of a sentence extraction device, a kanji-character conversion candidate extraction unit 4, an input candidate display control unit 5, a search result display control unit 6, a search method determination unit 7, a search process unit 8 as an example of a search device, a display 9, as an example of an output device which is composed of a liquid crystal display or the like, and a storage unit 10 in which, for example, a hard disc or the like is a recording medium.

In the storage unit 10, each of a next word predictive candidate data base 11 as an example of a second storage device, a keyword type data base 12 as an example of a first storage device, and a search data base 13 is stored in a non-volatile fashion. In the search data base 13, a variety of data base to be referred to at the time of performing an actual search operation using a keyword according to the embodiment formed by an operation mentioned later is included. In particular, for example, as shown in FIG. 1, s facility name data base 13A, an address data base 13B, and a telephone number data base 13C are included, and in addition thereto, a periphery search facility data base, a postcode data base, or the like may be included.

Now, each of the next word predictive candidate data base 11 and the keyword type data base 12 according to the embodiment which are stored in the storage unit 10 will be described in detail.

First, a detailed structure of the keyword type data base 12 will be described using FIG. 2A.

As illustrated in FIG. 2A, in the keyword type data base 12 according to the embodiment, a word/phrase 12A which is expected to be provided for a search as the whole or a portion of a free keyword (i.e., which is indefinite) is stored in such a way that the word/phrase 12A corresponds to a type identifier 12B indicative of a type of the word/phrase 12A in a search in a one-to-one relationship. One pair of type 12P is formed by one word/phrase 12A and one type identifier 12B, and the pairs of type 12P are stored in the keyword type data base 12 by the number of the words/phrases 12A in which the types are different and in such a way that the pairs of type 12P can be identified relative to each other.

Here, a “type” indicated by a type identifier 12B is an attribute (a type) which the corresponding word/phrase 12A has in an operation of search for a destination or the like according to the embodiment. In particular, for example, a word/phrase 12A, of “Aoyama” means a case in which it is a portion of an indication of an address (for example, “Aoyama” in an indication of an address of “ - - - , Kita-Aoyama, Minato-ward, Tokyo), a case in which it is a portion of a name of a facility (for example, “Aoyama” in a name of a facility of “Aoyama Museum”), and a case in which it is a portion of a name of a genre (for example, “Aoyama” in a name of a genre of “Aoyama-type oo”). In such a case, as a keyword type data base 12 according to the embodiment, one pair of type 12P is formed by a word/phrase 12A of “Aoyama”, and a type identifier 12B which means “an indication of an address”, for example, “KYAD”. Another pair of type 12P is formed by the same word/phrase 12A of “Aoyama”, and a type identifier 12B which means “a name of a facility”, for example, “KYPN”, and still another pair of type 12P is formed by a word/phrase 12A of “Aoyama”, and a type identifier 12B which means “a name of a genre”, for example, “KYGN”.

Now, a detailed structure of a next word predictive candidate data base 11 will be described with reference to FIG. 2B.

As illustrated in FIG. 2B, a next word predictive candidate data base 11 according to the embodiment is composed of a name candidate predictive type data base 20 as an example of a third storage device, a connective sentence data base 21 as an example of an attribute information-connective sentence pair storage device, and a designating sentence data base 22 as an example of an attribute information-designating sentence pair storage device.

In this arrangement, in the name candidate predictive type data base 20, a decided word/phrase 20A which is a word/phrase 12A which is decided to be used as the whole or a portion of a free keyword is stored in such a way that, in a keyword, the decided word/phrase 20A corresponds to a next word/phrase 20B connected immediately after the decided word/phrase 20A and forming a “name” as a portion of the keyword together with the decided word/phrase 20A, in a one-to-one relationship. By one decided word/phrase 20A and one next word/phrase 20B, one pair of name 20P is formed, and the pair of name 20P is stored in the name candidate predictive type data base 20 in such a way that there are the succeeding next word/phrase 20B, by the number of different decided words/phrases 20A, which can be identified relative to each other.

In particular, for example, when a next word/phrase 20B of “City” is connected immediately after a decided word/phrase 20A of “Akita”, it becomes to a name which can be included in a search keyword of “Akita-city”, and when a next word/phrase 20B of “Prefecture” is connected immediately thereafter, it becomes to a name of “Akita-prefecture”. Further, if a next word/phrase 20B of “Prefectural”, “Municipal”, or “Komachi” is connected immediately after the same decided word/phrase 20A of “Akita”, pairs of name 20P formed as a result thereof are stored in the name candidate predictive type data base 20 as different pairs.

Now, in the connective sentence data base 21, the type identifier 12B, and a connective sentence 21A which constitutes a portion or the whole of a natural sentence as a free keyword by being connected immediately after the word/phrase 12A in the case where the word/phrase 12A which constitutes the pair of type 12P together with the type identifier 12B are inputted as a portion of a keyword, are stored in a one-to-one relationship. By one type identifier 12B and one connective sentence 21A which relates to each other, one connective sentence 21P is formed, and pairs of connective sentence 21P are stored in the connective sentence data base 21 by the number of different connective sentences 21A in such a way that they can be identified relative to each other.

In particularly, for example, concerning, a word/phrase 12A which constitutes a pair of type 12P (for example, a word/phrase 12A of “Aoyama”) together with a type identifier 12B indicative of “an indication of an address”, as a connective sentence 21A connected immediately thereafter, there is a connective sentence 21A of contents called, for example, “on the periphery of”. Therefore, by a type identifier 12B indicative of “an indication of an address” and a connective sentence 21A of contents called “on the periphery of”, one pair of connective sentence 21P is formed, and stored in the connective sentence data base 21.

Further, concerning a word/phrase 12A which constitutes a pair of type 12P (for example, a word/phrase 12A of “Aoyama”) together with a type identifier 12B indicative of “a name of a facility”, as a connective sentence 21A connected immediately thereafter, there is a connective sentence 21A of contents called, for example, “including, as a name,”. Therefore, by a type identifier 12B indicative of “a name of a facility”, and a connective sentence 21A of contents called “including, as a name”, another pair of connective sentence 21P is formed, and stored in the connective sentence data base 21. Further, concerning a word/phrase 12A which constitutes a pair of type 12P (for example, a word/phrase 12A of “Aoyama”) together with a type identifier 12B indicative of “a name of a genre”, as a connective sentence 21A connected immediately thereafter, there is a connective sentence 21A of contents called, for example, “in a genre of”. Therefore, by a type identifier 12B indicative of “a name of a genre”, and a connective sentence 21A of contents called “in a genre of”, still another pair of connective sentence 21P is formed, and stored in the connective sentence data base 21.

Finally, in the designating sentence data base 22, the type identifier 12B, and a designating sentence 22A indicative of a specific search method (search contents) as a free keyword of a natural sentence by being connected immediately after the word/phrase 12A in the case where the word/phrase 12A which constitutes the pair of type 12P together with the type identifier 12B is inputted as a portion of a keyword, are stored in a one-to-one relationship. By one type identifier 12B and one designating sentence 22A which relate to each other, one pair of designating sentence 22P is formed, and pairs of designating sentence 21P are stored in the designating sentence data base 22 by the number of different designating sentences 22A in such a way that they can be identified relative to each other.

In particularly, for example, concerning a word/phrase 12A which constitutes a pair of type 12P (for example, a word/phrase 12A of “Aoyama”) together with a type identifier 12B indicative of “an indication of an address”, as a designating sentence 22A connected immediately thereafter, there is a designating sentence 22A of contents called, for example, “searching for an address starting with”. Therefore, by a type identifier 12B indicative of “an indication of an address” and a designating sentence 22A of contents called “searching for an address starting with”, one pair of designating sentence 22P is formed, and stored in the designating sentence data base 22.

Further, concerning a word/phrase 12A which constitutes a pair of type 12P (for example, a word/phrase 12A of “Aoyama”) together with a type identifier 12B indicative of “a name of a facility”, as a designating sentence 22A connected immediately thereafter, there is a designating sentence 22A of contents called, for example, “searching for a facility whose name includes”. Therefore, by a type identifier 12B indicative of “a name of a facility”, and a designating sentence 22A of contents called “searching for a facility whose name includes”, another pair of designating sentence 22P is formed, and stored in the designating sentence data base 22. Further, concerning a word/phrase 12A which constitutes a pair of type 12P (for example, a word/phrase 12A of “Aoyama”) together with a type identifier 12B indicative of “a name of a genre”, as a designating sentence 22A connected immediately thereafter, there is a designating sentence 22A of contents called, for example, “searching for a facility in a genre of”, “searching for a facility in a genre of, in the whole country”, “searching for a facility in a genre of, in the vicinity”, or the like. Therefore, by a type identifier 12B indicative of “a name of a genre”, and one designating sentence 22A of contents called “searching for a facility in a genre of” or the like, still another pair of designating sentence 22P is formed, and stored in the designating sentence data base 22.

By using a keyword type data base 12, and a next word predictive candidate data base 11 which includes a name candidate predictive type data base 20, a connective sentence data base 21, and a designating sentence data base 22, which have a structure mentioned above, in a search operation according to the embodiment mentioned below, a search keyword is inputted and decided using an easy-to-understand natural sentence.

### (II) Operation of Search Apparatus

Now, a search operation of a search apparatus S according to the embodiment will be described, mainly, with reference to FIG. 3 to FIG. 6.

As shown in FIG. 3, when a search operation of a search apparatus S according to the embodiment is started, first, a search screen 100 illustrated in FIG. 4 is displayed on a display 9 (step S1). Here, a structure of the search screen 100 will be described with reference to FIG. 4.

As illustrated in FIG. 4, the search screen 100 is composed of an input display part 101 in which an input result, a Kanji-character conversion result, and the like are displayed, a search button 102 operated by a mouse or the like not shown at the time of conducting a search, a predictive candidate display part 103 in which one or a plurality of predictive candidates according to the embodiment are displayed, and a keyboard display part 104 which includes a plurality of input keys K which correspond to Hiragana-characters, Katakana-characters, numerals, and signs, respectively. In FIG. 4, although the keyboard display part 104 in which input keys K each of which corresponds to one of Hiragana-characters, and an input key K which corresponds to a so-called back space (“BS”) are displayed are illustrated, by an operation of a switch button not shown or the like, a display of the keyboard display part 104 can be changed to a display of input keys K each of which corresponds to one of Katakana-characters, numerals, or signs. By operating each input key K displayed in the keyboard display part 104, for example, with a touch panel (not shown) attached to a surface of the display 9 or the like, a desired character string which constitutes a keyword is inputted. An input of keyword may be arranged to be performed by using a keyboard (not shown) which constitutes a operation unit 1 (an actual keyboard which has a plurality of keys).

When the above search screen 100 is displayed in a display 9 (step S1), and a character string such as Hiragana-character is inputted based on an operation of an input key K displayed in a keyboard display part 104 or the like, contents of the inputted character string is recognized by a key input control unit 2.

Now, a Kanji-character conversion candidate for the inputted character string, i.e., a Kanji-character conversion candidate which is a candidate of a name or the like including Kanji-character corresponding to the inputted character string is extracted by a Kanji-character conversion candidate extraction unit 4, and the extracted Kanji-character conversion candidates are displayed in a list fashion in a predictive candidate display part 103 by an input candidate display control unit 5. When an operation of selecting one in the displayed Kanji-character conversion candidates is performed, one word/phrase which constitutes a keyword is decided by the above operation.

When a word/phrase is decided by the above operation, then, a next word predictive candidate extraction unit 3 refers to a next word predictive candidate data base 11 and a keyword type data base 12 in a storage unit 10, extracts a connective sentence 21A or a designating sentence 22A following the decided word/phrase as a predictive candidate according to the embodiment, and an input candidate display control unit 5 displays the extracted connective sentence 21A or the like in a predictive candidate display part 103 in a list fashion (step S2). At this time, as mentioned later, in addition to the connective sentence 21 or the like, the above decided word/phrase (a decided word/phrase 20A, a next word/phrase 20B, and the like) is displayed together in the predictive candidate display part 103 in a list fashion.

A keyword which comprises a plurality of words/phrases including a decided word/phrase 20A or the like, and a connective sentence 21A or a designating sentence 22A connecting them is formed as mentioned above, and then, based on the fact that a search button 102 is operated, or the above designating sentence 22A included in the formed keyword is selected through a key input control unit 2, it is confirmed whether a start of a search operation using the formed keyword is instructed (step S3). When a start of a search operation is not instructed (step S3, NO), that effect is outputted to a next word predictive candidate extraction unit 3, the next word predictive candidate extraction unit 3 which has received the effect returns to the step S2, and successively, a forming operation of a keyword is continued. On the other hand, when a start of a search operation is instructed in a confirmation process of step S3 (step S3, Yes), a search method determination unit 7 and a search process unit 8 perform a search operation using the formed keyword (steps S4 to S16).

Here, the above steps S1 and S2 will be described in more detail with reference to FIGS. 5A to 5E.

First, assuming that an input key K displayed in a keyboard display part 104 in a search screen 100 displayed in an operation of the above step S1 is operated, and a user who performs a search operation using a search apparatus S inputs “Yo”, and then “Ko”, that effect is displayed as “Yo Ko” in an input display part 101 as illustrated in FIG. 5A. When the “Yo Ko” is decided as an inputted character string (in FIG. 5A, a character is displayed in reverse video), one or a plurality of Kanji-character conversion candidates which are words/phrases which include Kanji-character corresponding to the decided character string and are expected from the decided character string are displayed in a predictive candidate display part 103 in a list fashion, as illustrated in FIG. 5A. At this time, the display of Kanji-character conversion candidate is performed, for example, by searching a word/phrase which is composed of Kanji-character which includes “Yo Ko” as a reading Kana-character, in a Kanji-character conversion data base (not shown) stored in a storage unit 10.

From a Kanji-character conversion candidate displayed in a list fashion (in the case where a Kanji-character conversion candidate is illustrated in FIG. 5A, from“Yokohama”, “Yokosuka”, “Yokogawa”, “Yokokawa”, - - - ), a Kanji-character conversion candidate desired by a user (i.e., a Kanji-character conversion candidate corresponding to a word/phrase which is intended to be included in a keyword by inputting “Yo Ko”) is selected, and then, the selected Kanji-character conversion candidate is displayed in a predictive candidate display part 103 as illustrated in FIG. 5B. Further, it is reflected in an input display part 101, and one word/phrase (in the case of illustration in FIG. 5B, “Yokohama”) is decided as constituting a keyword.

Now, when a word/phrase is decided, a next word predictive candidate extraction unit 3 refers to a next word predictive candidate data base 11 and a keyword type data base 12 in a storage unit 10, and extracts a connective sentence 21A or a designating sentence 22A following the decided word/phrase as a predictive candidate according to the embodiment.

More particularly, first, when one word/phrase of the above “Yokohama” is decided as a word/phrase constituting a keyword, a next word predictive candidate extraction unit 3 refers to a keyword type data base 12 (see FIG. 2A), and extracts a type identifier 12B which constitutes a pair of type 12P together with a word/phrase 12A of the “Yokohama”. Therefore, a next word predictive candidate extraction unit 3 refers to a connective sentence data base 21 and a designating sentence data base 22 in a next word predictive candidate data base 11 at this time, and extracts a connective sentence 21A or a designating sentence 22A which constitutes a pair of connective sentence 21P or a pair of designating sentence 22P, respectively, together with the extracted type identifier 12B.

In addition thereto, the next word predictive candidate extraction unit 3 also refers to a name candidate predictive type data base 20 in a next word predictive candidate data base 11, and extracts a next word/phrase 20B which constitutes a pair of name 20P together with a decided word/phrase of “Yokohama” (a decided word/phrase 20A).

Therefore, an input candidate display control unit 5 displays a connective sentence 21A, a designating sentence 22A, and a next word/phrase 20B extracted by the next word predictive candidate extraction unit 3 in a predictive candidate display part 103 in a list fashion, as illustrated in FIG. 5C. In the case of illustration in FIG. 5C, it is shown that words/phrases of “China-town”, “municipal”, and “station” are extracted as a next word/phrase 20B, and connective sentences 21A of “on the periphery of” and “including, as a name” are extracted. Further, it is shown that a designating sentence 22A of “searching for an address starting with” is extracted.

Assuming that, from predictive candidates shown in a predictive candidate display part 103 in a condition illustrated in FIG. 5C, as illustrated in FIG. 5D, for example, “on the periphery of” is selected and decided, the decided connective sentence 21A is displayed in an input display part 101 as a connective sentence 21A following “Yokohama” of the decided word/phrase 20, as illustrated in FIG. 5E.

After that, by repeating a decision of the above word/phrase 12A as a decided word/phrase 20A, an extraction/decision of a connective sentence 21A or a designating sentence 22A using a type identifier 12B which constitutes a pair of type 12P together with the decided word/phrase 20A (a word/phrase 12A), and a decision of a next word/phrase 20b based on a pair of name 20P, a keyword in which a natural sentence desired by a user is used is successively formed. In this case, there are a case in which a word/phrase 12A is inputted by operating an input key K or the like displayed in a keyboard display part 104, and a case in which a predictive candidate displayed in a predictive candidate display part 103 in a list fashion is selected, and a connective sentence 21A, a designating sentence 22A, or a next word/phrase 20B is decided. In connection therewith, FIG. 5E illustrates as follows: after the above “on the periphery of” is decided as a connective sentence 21A, further, “market” as a word/phrase 12A is decided as a next word/phrase 20B, and based on a type identifier 12B corresponding to a case in which the “market” is regarded as a word/phrase 12A, “in a genre of” and “including, as a name” are extracted as a connective sentence 21A, and based on the type identifier 12B, “searching for a facility in a genre of” and “searching for a facility whose name includes” are extracted as a designating sentence 22A, and therefrom, “searching for a facility in a genre of” is selected as a designating sentence 22A.

Now, an operation after a case where a keyword in which a natural sentence is used by the above-mentioned operation is formed, and a start of a search operation is instructed (see step S3, YES) will be concretely described.

In the case where, based on an operation of a search button 102, or based on a selection of the designated sentence 22A included in a formed keyword, a formed keyword is decided, and a start of a search operation using the keyword is instructed (step S3, YES), first, a search method determination unit 7 breaks down the decided keyword in a condition where one or a plurality of names are a unit (step S4). Concerning an operation of the break-down, in particular, a search method determination unit 7 regards any of a connective sentence 21A, a designating sentence 22A, or a blank in the decided keyword as a partition, and breaks down the keyword in the condition where a name is a unit. Therefore, in a condition where a name put between the broken-down partitions is a unit, the search method determination unit 7 repeats steps S5 to S9 mentioned below, by the number of the units.

That is, first, a search method determination unit 7 refers to a keyword type database 12, and extracts all of type identifiers 12B which constitutes a pair of type 12P together with a word/phrase 12A corresponding to a name of a broken-down first unit (in the case of illustration in FIGS. 5A to 5E, “Yokohama”), from a keyword type data base 12, and temporarily stores the same in a memory (not shown) (step S6).

Now, a search method determination unit 7 confirms whether a blank, or any of a connective sentence 21A or a designating sentence 22A is between the name, and another name existing behind the name in a decided keyword (in the case of illustration in FIG. 5A to 5E, “market”) (step S7). In the case where a blank is therebetween (step S7, blank), the search method determination unit 7 moves to an operation of step S10 mentioned later.

On the other hand, in the case where any of a connective sentence 21A or a designating sentence 22A is therebetween (step S7, predictive candidate), then, the search method determination unit 7 refers to a connective sentence data base 21 and a designating sentence data base 22, and confirms whether any of a type identifier 12B which constitutes a pair of connective sentence 21P together with a connective sentence 21A confirmed to exist therebetween in the step S7, or a type identifier 12B which constitutes a pair of designating sentence 2 2 P together with a designating sentence 22A existing therebetween in the step S7 is included in a type identifiers 12B temporarily stored in a memory (not shown) in a operation of the step S6 (step S8).

Therefore, in the case where any of a type identifier 12B which constitutes a pair of connective sentence 21P together with a connective sentence 21A, or a type identifier 12B which constitutes a pair of designating sentence 22P together with a designating sentence 22A is included in the stored type identifiers 12B (step S8, YES), a search method determination unit 7 discards a type identifiers 12B other than any of a type identifier 12B which constitutes a pair of connective sentence 21P together with a connective sentence 21A, or a type identifier 12B which constitutes a pair of designating sentence 22P together with a designating sentence 22A, from type identifiers 12B stored in the above memory (not shown) (step S9), and moves to an operation of step S10 mentioned later.

On the other hand, in a confirmation of step S8, in the case where any of a type identifier 12B which constitutes a pair of connective sentence 21P together with a connective sentence 21A, or a type identifier 12B which constitutes a pair of designating sentence 22P together with a designating sentence 22A is not included in the stored type identifiers 12B (step S8, NO), a search method determination unit 7 gives an alarm indicating that a search operation based on a decided keyword cannot be performed, for example, on a display 9 through a search result display control unit 6 (step S16), and terminates a search operation as a search apparatus S according to the embodiment.

A search method determination unit 7 decides a type identifier 12B corresponding to each name provided to a search operation, by repeating an operation of the above steps S6 to S9 for each name included in a decided keyword.

When a type identifier 12B corresponding to each name is decided, then, a search method determination unit 7 decides a search conducting method provided to a search operation, by an operation mentioned below (steps S10 to S13).

That is, a search method determination unit 7 first refers to a keyword type data base 12, extracts all of designating sentences 22A which constitutes a pair of designating sentence 22P together with a type identifier 12B (the type identifier 12B is already decided by an operation of the above steps S6 to S9 for each name) which constitutes a pair of type 12P together with a word/phrase 12A corresponding to each broken-down name (in the case of illustration in FIG. 5A to 5E, “Yokohama” and “market”), from a designating sentence data base 22, and temporarily stores the same in the memory (step S10).

Now, a search method determination unit 7 confirms whether any designating sentence 22A is included (is selected) in a decided keyword (step S11). In the case of illustration in FIG. 5A to 5E, a designating sentence 22A of “searching for a facility in a genre of” is included.

In the above determination of step S11, in the case where any designating sentence 22A is not selected as a keyword (step S11, NO), a search method determination unit 7 moves to an operation of step S14 mentioned later. On the other hand, in the case where any designating sentence 22A is selected as a keyword (step S11, YES), then, a search method determination unit 7 confirms whether the selected designating sentence 22A is included in designating sentences 22A temporarily stored in a memory (not shown) in an operation of the step S10 (step S12). Therefore, in the case where the selected designating sentence 22A is included (step S12, YES), the search method determination unit 7 discards a designating sentence 22A other than the selected designating sentence 22A, from a designating sentence 22A stored in the memory not shown (step S13), and moves to an operation of step S14 mentioned later. On the other hand, in a confirmation of step S12, in the case where the selected designating sentence 22A is not included in a designating sentence 22A temporarily stored in the memory (step S12, NO), the search method determination unit 7 gives an alarm indicating that a search operation based on a decided keyword cannot be performed (step s16), and terminates a search operation as a search apparatus S according to the embodiment.

When a name provided for a search operation, and for example, a search conducting method illustrated in a designating sentence 22A are actually decided by an operation of the above steps S5 to S13, then the search method determination unit 7 decides one search conducting method illustrated in a designating sentence 22A considered to be most suitable, for example, in the case where a plurality of designating sentences 22A are selected, or the like, by a method similar to a conventional method (step S14), and outputs the result to a search process unit 8.

Therefore, based on the outputted search conducting method and keyword, the search process unit 8 searches a necessary designation or the like, using a search data base 13, and displays the result on a display 9 through a search result display control unit 6 (step S15), and then, terminates a search operation as a search apparatus S according to the embodiment.

Here, as a search result screen displayed on a display 9 as the search result, for example, as illustrated in FIG. 6, a search result screen 200 which includes a keyword display part 201 in which a keyword as a search method used to obtain the result is displayed, a result display part 202 in which a name of a location as a search result is displayed, and a condition change button 203 operated at the time of changing a keyword or the like, are thought.

As the relationship between a keyword provided for a search operation mentioned above, and a destination or the like displayed in a result display part 202 as a result of a search operation according to the embodiment in which the keyword is used, for example, there are (A) to (D) illustrated in the following:
(A) When a search operation according to the embodiment is performed using a keyword which includes “Yokohama” (a decided word/phrase 20A), “on the periphery of” (a connective sentence 21A), “market” (a next word/phrase 20B), and “searching for a facility in a genre of” (a designating sentence 22A), concretely, “a facility of a market on the periphery of Yokohama” is searched, and as a result thereof, for example, “Yokohama-city oo wholesale market”, “Kawasaki\hat{-} \hat{-}market” and the like are obtained.
(B) When a search operation according to the embodiment is performed using a keyword which includes “Yokohama” (a decided word/phrase 20A), “on the periphery of” (a connective sentence 21A), “market” (a next word/phrase 20B), and “searching for a facility whose name includes” (a designating sentence 22A), concretely, “a facility whose name includes “market” on the periphery of Yokohama” is searched, and as a result thereof, for example, “Yokohama-city oo wholesale market”, “Yokohama Bank <> <> market branch”, “Japanese-style bar oo market”, and the like are obtained.
(C) When a search operation according to the embodiment is performed using a keyword which includes “Yokohama” (a decided word/phrase 20A), “on the periphery of” (a connective sentence 21A), “market” (a next word/phrase 20B), and “including as a name” (a connecting sentence 21A), “sushi” (a next word/phrase 20B), and “searching for a facility in a genre of” (a designating sentence 22A), concretely, “a sushi restaurant whose name includes “market” on the periphery of Yokohama” is searched, and as a result thereof, for example, “<> market sushi, Yokohama-ekimae shop”, “Yamato <> <> sushi, market shop”, and the like are obtained.
(D) When a search operation according to the embodiment is performed using a keyword which includes “Yokohama” (a decided word/phrase 20A), “including as a name” (a connective sentence 21A), “market” (a next word/phrase 20B), and “searching for a facility in a genre of” (a designating sentence 22A), concretely, “a market facility whose name includes “Yokohama” in the whole country” is searched, and as a result thereof, for example, “Yokohama-city oo wholesale market”, “Tsugaru Yokohama <> market”, and the like are obtained.

As mentioned above, in accordance with a search operation performed by a search apparatus S according to the embodiment, a word/phrase 12A which is expected to be inputted as a keyword, a type identifier 12B indicative of an attribute as a keyword of the word/phrase 12A are connected to each other as a pair of type 12P, and based on the pair of type 12P, a connective sentence 21A or the like which is expected to be inputted together with the word/phrase 12A, and the like are extracted, and a candidate of a keyword which includes the same is outputted. Therefore, by the fact that a candidate which is composed of a word/phrase 12A, a connective sentence 21A, and the like is outputted, it is possible to recognize and determine contents of a keyword in a simple arrangement and as an easy-to-understand-naturally sentence with precision kept as a keyword

A connective sentence 21A corresponding to a type identifier 12B is extracted using a pair of connective sentence 21P stored in a connective sentence data base 21, and a predictive candidate which includes an inputted word/phrase 12A, and an extracted connective sentence 21A is outputted. Therefore, it is possible to recognize and determine contents of a keyword as an easy-to-understand-more-naturally sentence.

Further, a designating sentence 22A corresponding to a type identifier 12B is extracted using a pair of designating sentence 22P stored in a designating sentence data base 22, and a predictive candidate which includes an inputted word/phrase 12A, and an extracted designating sentence 22A is outputted. Therefore, it is possible to recognize and determine contents of a keyword as an easy-to-understand-more-naturally sentence.

Furthermore, in addition to an inputted word/phrase 12A, a connective sentence 21A corresponding thereto, and the like, a predictive candidate which includes a next word/phrase 20B corresponding to the word/phrase 12A is outputted, and therefore, precision as a keyword is more kept.

In the above embodiment, a case where a keyword provided for a search operation is a keyword which includes a decided word/phrase 20A (a word/phrase 12A), a next word/phrase 20B, a connective sentence 21A, and a designating sentence 22A has been described. In addition thereto, for example, it is also possible that a candidate for designating that the relationship between a previously decided name and a name inputted thereafter is AND condition or OR condition as a search condition is included in a next word predictive candidate data base 11, and such a search condition is included in a keyword, and the keyword is decided. In this case, it is possible to form a more various and suitable keyword as a keyword.

Further, as illustrated in FIG. 2A, a keyword type data base 12 according to the embodiment mentioned above is arranged to store a pair of type 12P which is constituted by a type identifier 12B which means a name of a facility (for example, “KYPN”) for a word/phrase 12A which is a name of a facility itself or all of words/phrases 12A which become to a name of a facility based on a combination thereof with a next word/phrase 20B. However, as an arrangement other than the above arrangement, a pair of type 12P which includes a type identifier 12B which means a name of a facility is not stored as a keyword type data base 12, for example, such an arrangement is also possible that, in an operation of step S6 in FIG. 3, a type identifier 12B which means a name of a facility as a type identifier 12B of a so-called default is added for a name which can be a name of a facility, and is stored in a memory not shown (see step S6 in FIG. 3). In this case, it is possible to reduce an amount of information as a keyword type data base 12.

In the above embodiment, a case has been described in which the present invention has been applied to a search apparatus included in a navigation apparatus, for example, a search apparatus used at the time of searching a destination or the like relating to a guidance. However, In addition thereto, the present invention may be applied to, for example, a search for a destination of telephone, a search for a location, or the like in a mobile telephone.

Further, the following arrangement is also possible: a program corresponding to a flowchart shown in FIG. 3 is stored in a recording medium such as a flexible disc or a hard disc, or obtained through a network such as an internet, and by reading and executing the same by a general-purpose micro-computer, such a micro-computer is caused to function as a next word predictive candidate extraction unit 3, a Kanji-character conversion candidate extraction unit 4, a search method determination unit 7, and a search process unit 8, according to the embodiment.

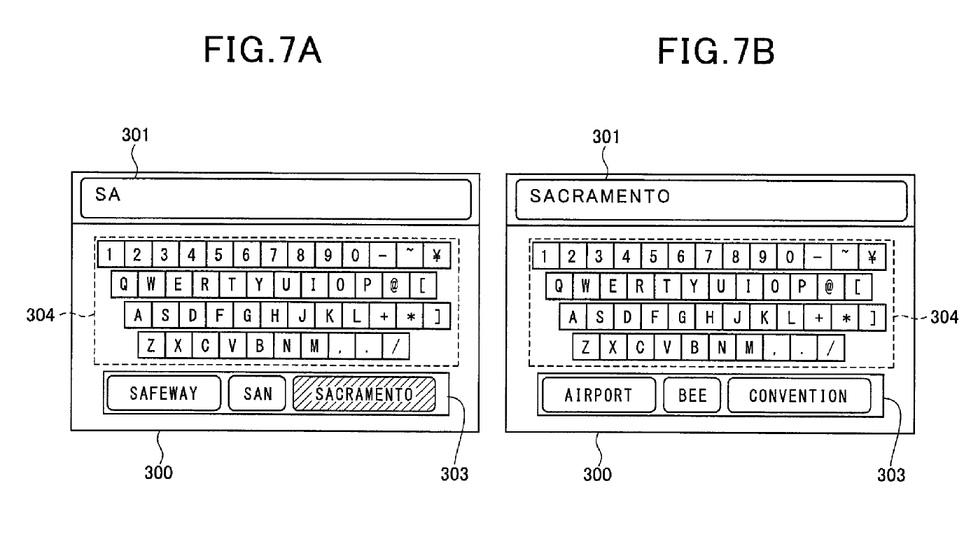

Further, while FIG. 4 shows an example in which a Kanji-character conversion candidate is displayed based on an input of Hiragana-character, a conversion (a prediction) of entire word from a portion of spelling is a premise in an area of Latin language such as English language, French language. FIGS. 7A and 7B show an example of such conversion (such prediction).

In FIGS. 7A and 7B, a search screen 300 includes a keyword input display part 301, a predictive-word candidate display part 303, and an alphabet-character-keyboard display part 304. In FIG. 7A, when a character of “S” and a character of “A” is inputted (see the keyword input display part 301), predictive-word candidates whose spellings start with “SA” are displayed, namely, predictive-word candidates of “SAFEWAY”, “SAN”, and “SACRAMENTO” are displayed (see the predictive-word candidate display part 303). When a predictive-word candidate of “SACRAMENTO” is selected, a spelling of “SA” being inputted is replaced with that word of “SACRAMENTO”. Please see the keyword input display part 301 in FIG. 7B. In the predictive-word candidate display part 303 of FIG. 7B, predictive-word candidates following “SACRAMENTO” are displayed, namely, predictive-word candidates of “AIRPORRT”, “BEE”, and “CONVENTION” are displayed.

It should be understood that various alternatives to the embodiment of the invention described herein may be employed in practicing the invention. Thus, it is intended that the following claims define the scope of the invention, and that methods and structures within the scope of these claims and their equivalents be covered thereby.

The entire disclosure of Japanese Patent Application No. 2009-144544 filed on Jun. 17, 2009 including the specification, claims, drawings and abstract is incorporated herein by reference in its entirety.

What is claimed is:

1. A search word candidate outputting apparatus, comprising:
a first storage device configured to store a pair of a word/phrase which is expected to be inputted as a search word used for a search, and attribute information indicative of an attribute as a search word of the word/phrase, as a pair of word/phrase-attribute information,
a second storage device configured to store a pair of the attribute information, and a sentence which is expected to be inputted together with the word/phrase for which the attribute is indicated by the attribute information, as a pair of attribute information-sentence,
an attribute information extraction device configured to, based on the stored pair of word/phrase-attribute information, extract the attribute information indicative of the attribute as the search word of the inputted word/phrase, from the first storage device,
a sentence extraction device configured to, based on the stored pair of attribute information-sentence, extract the sentence which constitutes the pair of attribute information-sentence together with the extracted attribute information, from the second storage device, and
an outputting device configured to output the inputted word/phrase and the sentence extracted from the sentence extraction device, as a candidate of the search word.

2. A search word candidate outputting apparatus according to claim 1,
wherein the second storage device includes a pair-of-attribute-information-and-connective-sentence storage device which stores a pair of the attribute information, and a connective sentence which is a sentence which is expected to be inputted following the word/phrase indicative of the attribute by the attribute information, and which is a sentence which has contents which correspond to the attribute and connect a plurality of the words/phrases, as a pair of attribute information-connective sentence,
the sentence extraction device, based on the stored pair of attribute information-connective sentence, extracts the connective sentence which constitutes the pair of attribute information-connective sentence together with the extracted attribute information, from the pair-of-attribute-information-and-connective-sentence storage device, and
the outputting device outputs the candidate which includes the inputted word/phrase, and the extracted connective sentence.

3. A search word candidate outputting apparatus according to claim 1,
wherein the second storage device includes a pair-of-attribute-information-and-designating-sentence storage device which stores a pair of the attribute information, and a designating sentence which is a sentence which is expected to be inputted following the word/phrase indicative of the attribute by the attribute information, and which is a sentence which has contents which designate a search method which corresponds to the attribute, as a pair of attribute information-designating sentence,
the sentence extraction device, based on the stored pair of attribute information-designating sentence, extracts the designating sentence which constitutes the pair of attribute information-designating sentence together with the extracted attribute information, from the pair-of-attribute-information-and-designating-sentence storage device, and
the outputting device outputs the candidate which includes the inputted word/phrase, and the extracted designating sentence.

4. A search word candidate outputting apparatus according to claim 1, further comprising:
a third storage device configured to store a name constituting word/phrase which is a word/phrase which constitutes a name in the search word and which is used together with the word/phrase, in such a way that it corresponds to the word/phrase which constitutes the name together with the name constituting word, and
a name constituting word extraction device configured to extract the name constituting word/phrase corresponding to the inputted word/phrase, from the third storage device,
wherein the outputting device outputs the candidate which includes the inputted word/phrase, the extracted sentence, and the extracted name constituting word/phrase.

5. A search apparatus, comprising:
a search word candidate outputting apparatus according to claim 1,
an inputting device configured to be used to input instructions of deciding the search word based on the outputted candidate, and
a search device configured to conduct a search using the decided search word.

6. A computer-readable recording medium in which a data structure is recorded,
wherein the data structure is a data structure in the first storage device provided in a search word candidate outputting apparatus according to claim 1,
the data structure includes the pair of word/phrase-attribute information which includes the word/phrase and the attribute information corresponding to the word/phrase in such a way that the pairs of word/phrase-attribute information can be identified relative to each other.

7. A computer-readable recording medium in which a data structure is recorded,
wherein the data structure is a data structure in the second storage device provided in a search word candidate outputting apparatus according to claim 1,
the data structure includes the pair of attribute information-sentence which includes the attribute information and the sentence corresponding to the attribute information in such away that the pairs of attribute information-sentence can be identified relative to each other.

8. A search word candidate outputting method performed in a search word candidate outputting apparatus which comprises:
a first storage device configured to store a pair of a word/phrase which is expected to be inputted as a search word used for a search, and attribute information indicative of an attribute as a search word of the word/phrase, as a pair of word/phrase-attribute information, and
a second storage device configured to store a pair of the attribute information, and a sentence which is expected to be inputted together with the word/phrase for which the attribute is indicated by the attribute information, as a pair of attribute information-sentence,
the method comprising:
an attribute information extraction step of, based on the stored pair of word/phrase-attribute information, extracting the attribute information indicative of the attribute as the search word of the inputted word/phrase, from the first storage device,
a sentence extraction step of, based on the stored pair of attribute information-sentence, extracting the sentence which constitutes the pair of attribute information-sentence together with the extracted attribute information, from the second storage device, and
an outputting step of outputting the inputted word/phrase and the sentence extracted from the sentence extraction device, as a candidate of the search word.

9. A computer-readable recording medium in which a search word candidate outputting program is recorded,
the program making a computer function as a search word candidate outputting apparatus according to claim 1.
